(19) United States
(12) Patent Application Publication
(10) Pub. No.: US 2010/0154099 A1
(43) Pub. Date: Jun. 24, 2010

(54) WATERPROOF GLOVES AND MANUFACTURING METHOD THEREOF

(76) Inventor: Myung-Chul LEE, Gwangju-si (KR)

Correspondence Address: CHRISTOPHER PAUL MITCHELL, 888 16TH ST., NW, SUITE 800, WASHINGTON, DC, 20006, US

(21) Appl. No.: 12/625,547

(22) Filed: Nov. 24, 2009

(30) Foreign Application Priority Data
Dec. 22, 2008 (KR) 10-2008-0130798

(51) Int. Cl. A41D 19/00; B32B 38/04

(52) U.S. Cl. 2/164; 156/256

(57) ABSTRACT

A waterproof glove has an outer shell, an inner liner and an intermediate liner interposed therebetween. Adhesive members are attached to predetermined portions of an outer surface of the inner liner and predetermined portions of an outer surface of the intermediate liner, adhesion parts are formed on first surfaces of the adhesive members which will come into close contact with the outer surface of the inner liner and the outer surface of the intermediate liner, and hot melt parts are formed on second surfaces of the adhesive members which will come into close contact with an inner surface of the intermediate liner and an inner surface of the outer shell.

### RELATED APPLICATIONS

This application claims priority under 35 U.S.C. 119(e) from Korean Patent Application No. 10-2008-0130798, filed Dec. 22, 2008 in the Korean Intellectual Property Office, which is incorporated herein by reference in its entirety.

### TECHNICAL FIELD

Embodiments of the present invention relate to a waterproof glove, and more particularly, to a waterproof glove in which adhesive members formed with hot melt parts are employed such that an outer shell, an inner liner and an intermediate liner (or membrane layer), interposed therebetween, of the glove can be heat-fused to one another so that water resistance is improved, protection against wind is enhanced and a manufacturing process is simplified so as to improve workability, and a method for manufacturing the same.

### BACKGROUND ART

In general, winter gloves are used to protect the hands of a wearer when carrying out work, driving a motorcycle or a car, or engaging leisure activities, such as fishing, skiing, and so on, in cold weather or in a cold region.

In particular, waterproof gloves undergo a waterproofing treatment to prevent permeation of water thereto. The waterproof gloves are manufactured using a material which can easily absorb and discharge sweat from a user.

The waterproof glove is usually composed of an outer shell, an inner liner, and an intermediate liner (or membrane layer) interposed therebetween. The inner liner is made of a material for thermal insulation, and the outer shell is made of a material for water resistance. The intermediate liner (or membrane layer) is made of a material for water resistance and easy absorption and discharge of sweat.

However, the waterproof glove entails a problem in that since it is not provided with separate means for sewingly joining the inner liner and the outer shell to the intermediate liner, it is difficult to precisely sewingly join the inner liner and the outer shell to the intermediate liner in a state where the inner liner and the outer shell are held in position.

In order to overcome this problem, Korean Utility Model Registration No. 0398602 entitled “An intermediate liner joining structure for a watertight glove” has been disclosed in the art. In this structure, an intermediate liner and an inner liner/an outer shell can be easily joined to each other using junction tab members mounted to the finger tip portions of the glove.

Nevertheless, the intermediate liner joining structure for a watertight glove which uses the junction tab members involves a problem in that since the junction tab members are likely to be separated from the finger tip portions of the glove during sewing, the inner liner, the outer shell and the intermediate liner of the glove cannot be reliably kept joined to each other. Also, the inner liner and the outer shell can be easily damaged due to the formation of stitching lines, and there is a high probability that the inner liner/the outer shell and the intermediate liner will be easily separated from each other.

Further, in the case where bonding treatment is conducted for the intermediate liner so as to impart some stiffness to the glove, difficulties exist in conducting the bonding treatment, and wearing comfort of the glove deteriorates. In addition, the number of processes increases, resulting in an increase in the manufacturing cost.

### DISCLOSURE

### Technical Problem

Accordingly, an embodiment of the present invention has been made in an effort to solve the problems occurring in the related art, and an aspect of an embodiment of the present invention is to provide a waterproof glove in which adhesive members formed with hot melt parts are employed such that an outer shell, an inner liner and an intermediate liner, interposed therebetween, of the glove can be heat-fused to one another so that water resistance is improved, protection against wind is enhanced by the hot melt parts and a manufacturing process is simplified so as to improve workability, and a method for manufacturing the same.

### Technical Solution

In order to achieve the above and other aspects, according to one embodiment of the present invention, there is provided a waterproof glove having an outer shell, an inner liner and an intermediate liner interposed therebetween, including adhesive members attached to predetermined portions of an outer surface of the inner liner and predetermined portions of an outer surface of the intermediate liner, adhesion parts formed on one surface of the adhesive members which will come into close contact with the outer surface of the inner liner and the outer surface of the intermediate liner, and hot melt parts formed on the other surfaces of the adhesive members which will come into close contact with an inner surface of the intermediate liner and an inner surface of the outer shell.

The adhesive members may be attached to finger tip portions of the inner liner in a shape of a thimble.

Each adhesive member may include a release paper, an adhesion part, a base fabric and a hot melt part in this order.

According to another embodiment of the present invention, there is provided a method for manufacturing a waterproof glove comprising an outer shell, an inner liner and an intermediate liner interposed therebetween, including: preparing adhesive members which have adhesion parts and hot melt parts respectively formed on both surfaces of base fabrics, cutting the adhesive members into a predetermined shape and attaching the adhesive members to predetermined portions of an outer surface of the inner liner, joining the intermediate liner to the inner liner to which the adhesive members are attached, heating the joined portions of the intermediate liner and the adhesive members, attaching adhesion parts of adhesive members to predetermined portions of an outer surface of the intermediate liner which is joined to the inner liner, joining the outer shell to the intermediate liner which is joined to the inner liner and to which the adhesive members are attached, and setting a resultant joined structure in a hand form, completely joining the outer shell and the intermediate liner to each other in a setting machine which is heated to a predetermined temperature, and taking a resultant glove out of the setting machine.

### Advantageous Effects

According to the construction and method as described above, an embodiment of the present invention has advantageous effects in that adhesive members formed with hot melt parts are employed such that an outer shell, an inner liner and an intermediate liner, interposed therebetween, of the glove can be heat-fused to one another so that water resistance is improved, protection against wind is enhanced since the adhesive members are attached to the tip portions of glove fingers (which may be more sensitive to cold) without leaving open spaces, and a manufacturing process is simplified so as to improve workability.

Also, owing to the fact that the inner liner and the outer shell can be joined to the intermediate liner using the adhesive members without the need of conducting a separate bonding process for the intermediate liner of the glove, the same effect as that of the bonding treatment can be attained.

### DESCRIPTION OF DRAWINGS

The above aspects, and other features and advantages of the present invention will become more apparent after a reading of the following detailed description taken in conjunction with the drawings, in which:

FIG. 1 is a view illustrating a state in which adhesive members are attached to an inner liner of a waterproof glove according to an embodiment of the present invention;

FIG. 2 is a schematic cross-sectional view illustrating the structure of an adhesive member according to an embodiment of the present invention;

FIG. 3 is a view illustrating a state in which an intermediate liner is joined to the inner liner of the waterproof glove shown in FIG. 1;

FIG. 4 is a view illustrating a state immediately before the intermediate liner having adhesive members attached thereto is inserted into an outer shell of the waterproof glove shown in FIG. 1;

FIG. 5 is a view illustrating a state in which adhesive members are attached to an inner liner of a waterproof glove according to a variation of the present invention; and

FIG. 6 is a flow chart explaining a process for manufacturing a waterproof glove according to another embodiment of the present invention.

### BEST MODE

Reference will now be made in greater detail to embodiments of the invention, examples of which are illustrated in the accompanying drawings. Wherever possible, the same reference numerals will be used throughout the drawings and the description to refer to the same or like parts.

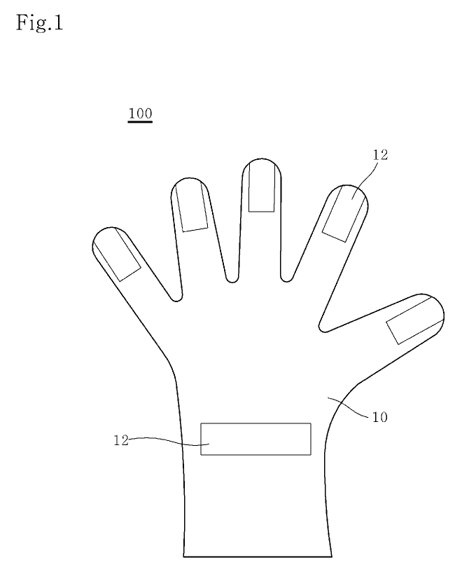

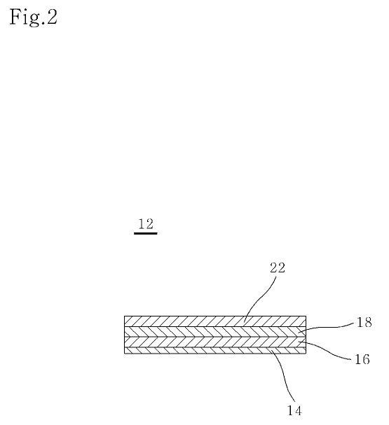

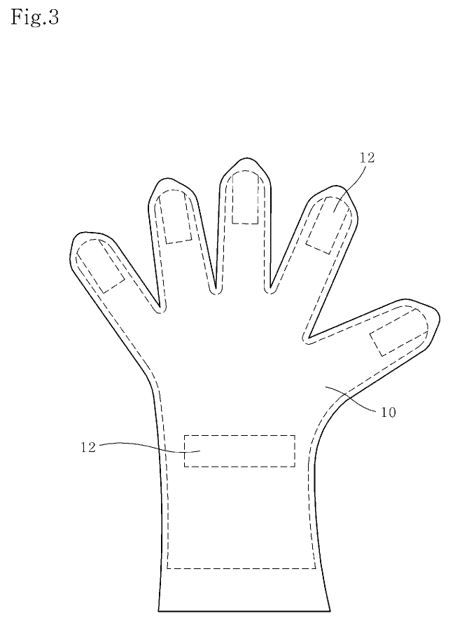

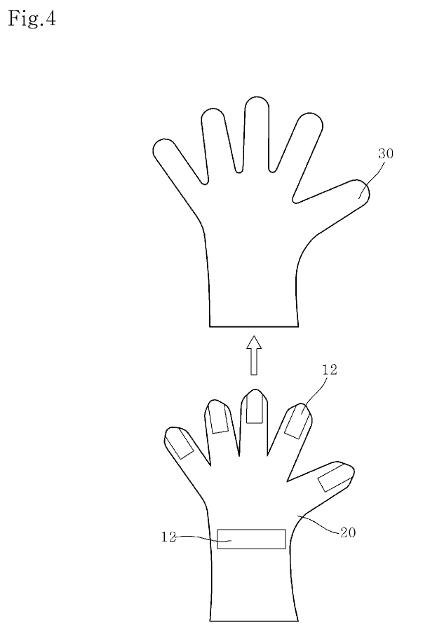

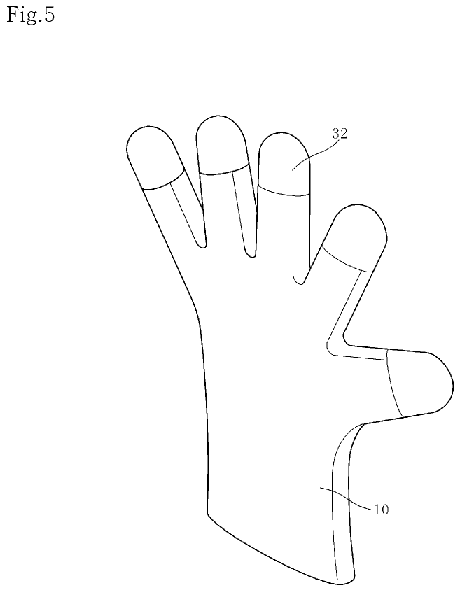

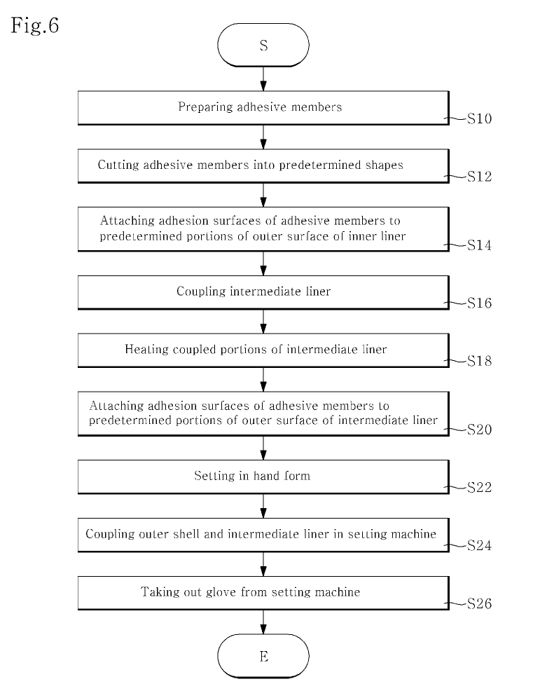

FIG. 1 is a view illustrating a state in which adhesive members are attached to an inner liner of a waterproof glove according to an embodiment of the present invention. FIG. 2 is a schematic cross-sectional view illustrating the structure of an adhesive member according to an embodiment of the present invention. FIG. 3 is a view illustrating a state in which an intermediate liner is joined to the inner liner of the waterproof glove shown in FIG. 1. FIG. 4 is a view illustrating a state immediately before the intermediate liner having adhesive members attached thereto is inserted into an outer shell of the waterproof glove shown in FIG. 1. FIG. 5 is a view illustrating a state in which adhesive members are attached to an inner liner of a waterproof glove according to a variation of the present invention. FIG. 6 is a flow chart explaining a process for manufacturing a waterproof glove according to another embodiment of the present invention.

Referring to the drawings, a waterproof glove according to an embodiment of the present invention generally may include an inner liner 10, an outer shell 30, and an intermediate liner 20 interposed therebetween.

Specifically, adhesive members 12 may be attached to predetermined portions of the outer surface of the inner liner 10 and predetermined portions of the outer surface of the intermediate liner 20. Each adhesive member 12 may be composed of a release paper 14, an adhesion part 16, a base fabric 18 and a hot melt part 22 as shown in FIG. 2.

In an embodiment of the present invention, the adhesive members 12 may be attached to the tip portions of the glove fingers and the hand back portion of each of the inner liner 10 and the intermediate liner 20 by removing release papers 14 therefrom. The attachment of the adhesive members 12 may be to precisely join the inner liner 10 and the intermediate liner 20 in a state where the inner liner 10 and the intermediate liner 20 may be held in position.

Adhesion parts 16 may be formed on the surfaces of the adhesive members 12 which may come into close contact with the outer surface of the inner liner 10 and the outer surface of the intermediate liner 20, and hot melt parts 22 may be formed on the surfaces of the adhesive members 12 which may come into close contact with the inner surface of the intermediate liner 20 and the inner surface of the outer shell 30.

The reason of forming the hot melt parts 22 as heat sensitive adhesive parts may be that when predetermined temperature and pressure may be externally applied to the hot melt parts, they may melt so that the inner liner 10, the outer shell 30 and the intermediate liner 20 may be completely fused with one another.

Adhesive members 32 may be formed in the shape of a thimble and may be attached to the tip portions of the glove fingers as shown in FIG. 5 so that a manufacturing process may be simplified, and protection against wind and thermal insulation may be enhanced due to the attachment of the thimble-shaped adhesive members 32. Further, it may be possible to prevent the tip portions of the glove fingers from being overly stiff unlike the case of the conventional art in which a bonding treatment is directly performed.

Hereinbelow, a method for manufacturing a waterproof glove according to another embodiment of the present invention will be described in detail with reference to the accompanying drawings.

First, the adhesive members 12 may be prepared in which the adhesion parts 16 and the hot melt parts 22 may be placed on both surfaces, i.e., the top surface and the bottom surface of the base fabrics 18, and may be cut into a predetermined shape such as of a plate and a thimble (S10 and S12).

Then, the cut adhesive members 12 may be attached to the finger tip portions and the hand back portion of the outer surface of the inner liner 10. Alternatively, the adhesive members 12 may be attached to the entire hand back portion of the outer surface of the glove (S14).

Owing to this fact, when compared to the conventional art in which a bonding treatment is implemented, a process for sewingly joining the inner liner, the outer shell and the intermediate liner to one another may be simplified, and it may be possible to prevent the glove from being overly stiff.

Next, the intermediate liner 20 may be joined to the inner liner 10 to which the adhesive members 12 may be attached, and portions of the intermediate liner 20 and the inner liner 10 which may be joined to each other may be heated such that the hot melt parts 22 of the adhesive members 12 may be melted and fused (S16 and S18).

In general, heating of the hot melt parts 22 may be performed using a heat press.

Thereafter, in the same manner as described above, the adhesion parts 16 of the adhesive members 12 may be attached to predetermined portions of the outer surface of the intermediate liner 20 which may be joined to the inner liner 10, in a state in which the release papers 14 may be removed from the adhesive members, the outer shell 30 may be joined to the intermediate liner 20 which may be joined to the inner liner 10, and the resultant joined structure may be set in a hand form which may be held under a cold (e.g., not heated) condition (S20 and S22).

Finally, after the glove may be set, the intermediate liner 20 joined with the inner liner 10 may be completely joined to the outer shell 30 in a setting machine which may be heated to a predetermined temperature. Thereafter, the glove may be taken out of the setting machine, whereby the manufacture of the waterproof glove may be completed.

Although embodiments of the present invention have been described for illustrative purposes, those skilled in the art will appreciate that various modifications, additions and substitutions are possible, without departing from the scope and spirit of the invention as disclosed in the accompanying claims and their equivalents.

1. A waterproof glove having an outer shell, an inner liner and an intermediate liner interposed therebetween, comprising:
adhesive members attached to predetermined portions of an outer surface of the inner liner and predetermined portions of an outer surface of the intermediate liner;
adhesion parts formed on one surface of the adhesive members which will come into close contact with the outer surface of the inner liner and the outer surface of the intermediate liner; and
hot melt parts formed on the other surfaces of the adhesive members which will come into close contact with an inner surface of the intermediate liner and an inner surface of the outer shell.

2. The waterproof glove according to claim 1, wherein the adhesive members are attached to finger tip portions of the inner liner in a shape of a thimble.

3. The waterproof glove according to claim 1, wherein each adhesive member comprises a release paper, an adhesion part, a base fabric and a hot melt part in this order.

4. The waterproof glove according to claim 2, wherein each adhesive member comprises a release paper, an adhesion part, a base fabric and a hot melt part in this order.

5. A waterproof glove, comprising:
an outer shell;
an intermediate liner; and
an inner liner;
where the outer shell is attached to the intermediate layer via a first adhesive member including an adhesion part and a hot melt part; and
where the intermediate layer is attached to the inner liner via a second adhesive member including an adhesion part and hot melt part.

6. The waterproof glove according to claim 5, wherein the second adhesive member is connected to a finger tip portion of the inner liner.

7. The waterproof glove according to claim 6, wherein the second adhesive member is in a shape of a thimble.

8. The waterproof glove according to claim 5, wherein the first and second adhesive members each comprise a release paper, the adhesion part, a base fabric and the hot melt part.

9. A method for manufacturing a waterproof glove comprising an outer shell, an inner liner and an intermediate liner interposed therebetween, comprising:
preparing adhesive members which have adhesion parts and hot melt parts respectively formed on both surfaces of base fabrics;
cutting the adhesive members into a predetermined shape and attaching the adhesive members to predetermined portions of an outer surface of the inner liner;
joining the intermediate liner to the inner liner to which the adhesive members are attached;
heating the joined portions of the intermediate liner and the adhesive members;
attaching adhesion parts of adhesive members to predetermined portions of an outer surface of the intermediate liner which is joined to the inner liner;
joining the outer shell to the intermediate liner which is joined to the inner liner and to which the adhesive members are attached, and setting a resultant joined structure in a hand form;
completely joining the outer shell and the intermediate liner to each other in a setting machine which is heated to a predetermined temperature; and
taking a resultant glove out of the setting machine.
